(19) United States
(12) Patent Application Publication
(10) Pub. No.: US 2017/0249898 A1
(43) Pub. Date: Aug. 31, 2017

(54) PIXEL CIRCUIT AND DRIVING METHOD THEREOF, DISPLAY SUBSTRATE, AND DISPLAY APPARATUS

(71) Applicant: Boe Technology Group Co., Ltd., Beijing (CN)

(72) Inventor: Zhanjie MA, Beijing (CN)

(73) Assignee: BOE Technology Group Co.,Ltd., Beijing (CN)

(21) Appl. No.: 15/519,632

(22) PCT Filed: Feb. 18, 2016
(86) PCT No.: PCT/CN2016/073991

§ 371 Date: Apr. 17, 2017

(30) Foreign Application Priority Data
Sep. 18, 2015 (CN) 201510601470.8

(51) Int. Cl. G09G 3/3233

(52) U.S. Cl. CPC G09G 3/3233; G09G 2320/0233; G09G 2310/0289; G09G 2300/0871; G09G 2300/0842

(57) ABSTRACT

The present disclosure provides a pixel circuit, a driving method, a display substrate, and a display apparatus. The pixel circuit includes a driving module, a capacitor module, a threshold voltage compensation and light emission control module, an electroluminescence module, a data voltage write module and a reset module. A driving current flowing through the electroluminescence module may be less than or even not influenced by the threshold voltage of a driving transistor, thus at least partially addressing the non-uniformity of display luminance due to drift of the threshold voltage of the driving transistor.

### CROSS-REFERENCE TO RELATED APPLICATIONS

The present application is the U.S. national phase entry of PCT/CN2016/073991, with an international filing date of Feb. 18, 2016, which claims the benefit of Chinese Patent Application No. 201510601470.8, filed on Sep. 18, 2015, the entire disclosures of which are incorporated herein by reference.

### TECHNICAL FIELD

The present disclosure relates to the field of display technologies, and particularly to a pixel circuit and a driving method thereof, a display substrate, and a display apparatus.

### BACKGROUND

Organic light-emitting diode (OLED) displays are among the hotspots of research today in the panel display field. As compared with liquid crystal displays (LCDs), OLED displays have advantages such as low power consumption, low manufacture cost, self-luminescence, a wide viewing angle, and fast responsiveness. Currently, traditional liquid crystal displays are being replaced by OLED displays in various display applications including cellphones, PDAs and digital cameras. It is of great significance to research the design of pixel driving circuits which is the core technique of the OLED display.

Different from the thin-film transistor (TFT)-LCD where the luminance is controlled utilizing a stable voltage, the OLED is a current-driving type device which requires a stable current for light emission control.

With a primitive 2T1C driving circuit (which includes two thin-film transistors and one capacitor), the driving TFTs of the pixel dots have respective different threshold voltages due to factors such as the fabrication process and device aging. This leads to the fact that the current flowing through the OLED varies from one pixel dot to another. As a result, the display luminance is non-uniform throughout the display screen, thus affecting the display effect.

### SUMMARY

It is an object of the present disclosure to alleviate, mitigate or eliminate the influence of the threshold voltage drift of a driving transistor on the driving current in an OLED pixel circuit.

According to a first aspect of the present disclosure, a pixel circuit is provided which comprises: an electroluminescence module adapted to emit light in response to a driving current; a driving module having a work voltage input terminal and connected to a first node and a second node, the driving module adapted to generate and output to the second node the driving current based on a difference between a difference between a voltage at the first node and a work voltage input via the work voltage input terminal and a threshold voltage of the driving module; a threshold voltage compensation and light emission control module having at least two control signal input terminals and an initialization voltage input terminal, and connected to the first node, the second node and the electroluminescence module, the threshold voltage compensation and light emission control module adapted to compensate the voltage at the first node to a sum of the threshold voltage of the driving module and the work voltage in response to a combination of levels at the at least two control signal input terminals being a first level combination, to initialize the first node by short-circuiting the first node to the initialization voltage input terminal in response to the combination of the levels at the at least two control signal input terminals being a second level combination, and to direct the driving current output to the second node by the driving module to the electroluminescence module in response to the combination of the levels at the at least two control signal input terminals being a third level combination; a data voltage write module having a data voltage input terminal and a control signal input terminal, and connected to a third node, the data voltage write module adapted to write a data voltage to the third node under control of a level at the control signal input terminal; a reset module having a reset voltage input terminal and a control signal input terminal, and connected to the third node, the reset module adapted to reset a voltage at the third node under control of a level at the control signal input terminal; and a capacitor module having a first terminal connected to the first node and a second terminal connected to the third node.

In an embodiment, the driving module comprises a P-type driving transistor having a gate connected to the first node, a drain connected to the second node, and a source connected to the work voltage input terminal.

In an embodiment, the threshold voltage compensation and light emission control module comprises a first switch transistor, a second switch transistor and a third switch transistor. The first switch transistor has a source, a drain, and a gate connected to a first control signal input terminal, one of the source and drain being connected to the first node, the other one being connected to the second node. The second switch transistor has a source, a drain, and a gate connected to a second control signal input terminal, one of the source and drain being connected to the second node, the other one being connected to the electroluminescence module. The third switch transistor has a source, a drain, and a gate connected to a third control signal input terminal, one of the source and drain being connected to the initialization voltage input terminal, the other one being connected to the drain of the second switch transistor.

In an embodiment, the third control signal input terminal and the first control signal input terminal are one and the same input terminal, and the third switch transistor has the same threshold voltage as the first switch transistor.

In an embodiment, the data voltage write module comprises a fourth switch transistor having a source, a drain, and a gate connected to a fourth control signal input terminal, one of the source and drain being connected to the data voltage input terminal, the other one being connected to the third node.

In an embodiment, the reset module comprises a fifth switch transistor having a source, a drain, and gate connected to the first control signal input terminal or the third control signal input terminal, one of the source and drain being connected to the reset voltage input terminal, the other one being connected to the third node.

In an embodiment, each of the switch transistors is a P-type transistor.

In an embodiment, the reset voltage input terminal and the work voltage input terminal are one and the same input terminal.

In an embodiment, the pixel circuit further comprises an auxiliary capacitor module having a first terminal connected to the third node and a second terminal connected to the work voltage input terminal.

According to a second aspect of the present disclosure, a method of driving the pixel circuit as described above is provided which comprises: initializing, at an initialization phase, the voltage at the first node by applying level signals of the second level combination to the control signal input terminals of the threshold voltage compensation and light emission control module; resetting, at a reset phase, the voltage at the third node by applying a control signal to the control signal input terminal of the reset module; compensating, at a threshold voltage compensation phase, the voltage at the first node to the sum of the threshold voltage of the driving module and the work voltage by applying level signals of the first level combination to the control signal input terminals of the threshold voltage compensation and light emission control module; applying, at a data voltage write phase, a control signal to the control signal input terminal of the data voltage write module, and a data voltage to the data voltage input terminal; and directing, at a light emission phase, the driving current output to the second node by the driving module to the electroluminescence module by applying level signals of the third level combination to the control signal input terminals of the threshold voltage compensation and light emission control module.

According to a third aspect of the present disclosure, a display substrate is provided which comprises the pixel circuit as described above.

According to a fourth aspect of the present disclosure, a display apparatus is provided which comprises the display substrate as described above.

In the pixel circuit according to embodiments of the present disclosure, the driving current flowing through the electroluminescence module may be less or even not influenced by the threshold voltage of the driving transistor, thus at least partially addressing the non-uniformity of display luminance due to the drift of the threshold voltage of the driving transistor.

### BRIEF DESCRIPTION OF THE DRAWINGS

FIG. 1 is a structural schematic diagram of a pixel circuit according to an embodiment of the present disclosure;

FIG. 2 is a circuit schematic diagram of a pixel circuit according to an embodiment of the present disclosure;

FIG. 3 is a timing diagram of example control signals for a pixel circuit according to an embodiment of the present disclosure;

FIGS. 4-7 are schematic diagrams of operation states of a pixel circuit according to an embodiment of the present disclosure in different phases; and

FIG. 8 is a graph showing a luminance variation versus a threshold voltage drift of a pixel circuit according to an embodiment of the present disclosure, wherein the luminance variation is represented by a current difference ratio.

### DETAILED DESCRIPTION

Embodiments of the present disclosure will be described below in detail with reference to the accompanying drawings. The following embodiments are described for a clear illustration of the technical solutions of the present disclosure only, rather than for purposes of restriction of the scope of the present disclosure.

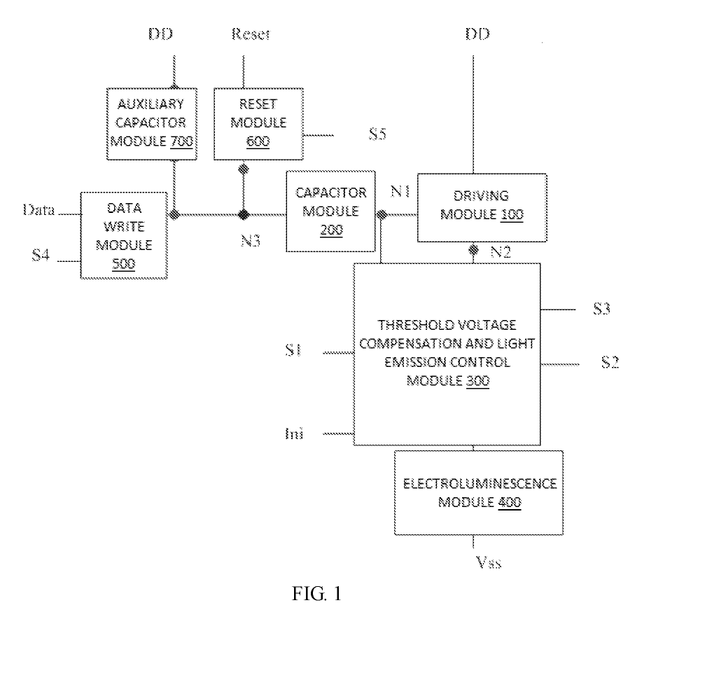

FIG. 1 is a structural schematic diagram of a pixel circuit according to an embodiment of the present disclosure. As shown in FIG. 1, the pixel circuit may include a driving module 100, a capacitor module 200, a threshold voltage compensation and light emission control module 300, an electroluminescence module 400, a data voltage write module 500 and a reset module 600. In addition, it further includes a work voltage input terminal DD, an initialization voltage input terminal Ini, a data voltage input terminal “Data”, a reset voltage input terminal “Reset” and multiple control signal input terminals (illustrated as S1 to S5 in this example).

The driving module 100 is connected to a first node N1, a second node N2 and the work voltage input terminal DD. The driving module 100 is adapted to generate and output to the second node N2 a corresponding driving current based on a difference between a difference between a voltage at the first node N1 and a work voltage Vdd input via the work voltage input terminal DD and a threshold voltage Vth of the driving module 100.

The threshold voltage compensation and light emission control module 300 is connected to three control signal input terminals S1, S2 and S3, and the initialization voltage input terminal Ini. The threshold voltage compensation and light emission control module 300 is further connected to the first node N1, the second node N2 and the electroluminescence module 400. The threshold voltage compensation and light emission control module 300 is adapted to compensate the level at the first node N1 to a sum of the threshold voltage Vth of the driving module 100 and the work voltage Vdd in response to a combination of levels at the control signal input terminals S1, S2 and S3 being a first level combination. The threshold voltage compensation and light emission control module 300 is further adapted to initialize the first node N1 by short-circuiting the first node N1 to the initialization voltage input terminal Ini in response to the combination of the levels at the control signal input terminals S1, S2 and S3 being a second level combination. The threshold voltage compensation and light emission control module 300 is further adapted to direct the driving current output to the second node N2 by the driving module 100 to the electroluminescence module 400 in response to the combination of the levels at the control signal input terminals S1, S2 and S3 being a third level combination.

The data voltage write module 500 is connected to a third node N3, the data voltage input terminal “Data” and the control signal input terminal S4. The data voltage write module 500 is adapted to write a data voltage Vdata to the third node N3 under control of a level at the control signal input terminal S4.

The reset module 600 is connected to the third node N3, the reset voltage input terminal “Reset” and the control signal input terminal S 5. The reset module 600 is adapted to reset a voltage at the third node N3 under control of a level at the control signal input terminal S5.

The capacitor module 200 has a first terminal connected to the first node N1 and a second terminal connected to the third node N3.

The work flow of the above pixel circuit may include several phases.

At an initialization phase, the voltage at the first node N1 is initialized. This may be achieved by applying level signals of the second level combination to the control signal input terminals of the threshold voltage compensation and light emission control module 300.

At a reset phase, the voltage at the third node N3 is reset. This may be achieved by applying a control signal to the control signal input terminal of the reset module 600.

At a threshold voltage compensation phase, the voltage at the first node N1 is compensated to the sum of the threshold voltage Vth of the driving module 100 and the work voltage Vdd. This may be achieved by applying level signals of the first level combination to the control signal input terminals of the threshold voltage compensation and light emission control module 300.

At a data voltage write phase, a control signal is applied to the control signal input terminal of the data voltage write module 500, and a data voltage is applied to the data voltage input terminal “Data”.

At a light emission phase, the driving current output to the second node N2 by the driving module 100 is directed to the electroluminescence module 400. This may be achieved by applying level signals of the third level combination to the control signal input terminals of the threshold voltage compensation and light emission control module 300.

In the following discussion, it will be appreciated that in the pixel circuit according to embodiments of the present disclosure the driving current flowing through the electroluminescence module 400 may be less or even not influenced by the threshold voltage Vth of the driving module 100, thus at least partially addressing the non-uniformity of display luminance due to the drift of the threshold voltage. Furthermore, initialization of the first node N1 can be done by the threshold voltage compensation and light emission control module 300 at the initialization phase, and resetting of the third node N3 can be done by the reset module 600 at the reset phase. This can prevent a previous frame displayed from influencing the display of a current frame.

In an implementation, the driving module 100 may be a P-type driving transistor. The gate of this P-type driving transistor is connected to the first node N1, the drain to the second node N2, and the source to the work voltage input terminal DD.

In an implementation, the threshold voltage compensation and light emission control module 300 may include a first switch transistor, a second switch transistor and a third switch transistor.

The gate of the first switch transistor is connected to the control signal input terminal S1. One of the source and drain of the first switch transistor is connected to the first node N1, and the other one to the second node N2. Taking a P-type transistor as an example, the first node N1 is connected to the source of the P-type transistor, and the second node N2 is connected to the drain of the P-type transistor. Taking an N-type transistor as an example, the first node N1 is connected to the drain of the N-type transistor, and the second node N2 is connected to the source of the N-type transistor. It will be appreciated by those skilled in the art that a suitable transistor type (either a P-type or an N-type) may be selected as appropriate. In addition, in some cases the source and the drain (of the thin-film transistor) may even be interchangeable.

The gate of the second switch transistor is connected to the control signal input terminal S2. One of the source and drain of the second switch transistor is connected to the second node N2, and the other one to the electroluminescence module 400. The gate of the third switch transistor is connected to the control signal input terminal S3. One of the source and drain of the third switch transistor is connected to the initialization voltage input terminal Ini, and the other one to the drain of the second switch transistor.

As such, the threshold voltage compensation and light emission control module 300 may have a simple structure since only three switch transistors are required. Also, control of the threshold voltage compensation and light emission control module 300 is simple because only three control signals are needed.

In particular, the third control signal input terminal S3 and the first control signal input terminal S1 may be one and the same input terminal, in which case the first switch transistor has the same threshold voltage as the third switch transistor. This can reduce the number of the control signals needed, and thus the number of the signal lines in the display apparatus. The same threshold voltage here may mean that the threshold voltages of both switch transistors are a high level or a low level. The high level here may refer to a gate voltage that is higher than the threshold voltage, and the low level may refer to a gate voltage that is lower than the threshold voltage.

In an implementation, the data voltage write module 500 may include a fourth switch transistor. The gate of the fourth switch transistor is connected to the fourth control signal input terminal S4. One of the source and drain of the fourth switch transistor is connected to the data voltage input terminal “Data”, and the other one to the third node N3.

In an implementation, the reset module 600 may include a fifth switch transistor. The gate of the fifth switch transistor is connected to the first control signal input terminal S5. One of the source and drain of the fifth switch transistor is connected to the reset voltage input terminal “Reset”, and the other one to the third node N3.

In particular, the reset voltage input terminal “Reset” and the work voltage input terminal Vdd may be one and the same input terminal. This can also reduce the number of the signal lines needed. In addition, the control signal input terminal S 5 and the control signal input terminal S1 or the control signal input terminal S3 may be one and the same input terminal, in which case the fifth switch transistor has the same threshold voltage as the switch transistor that is connected to the same signal input terminal. Likewise, such a design may also reduce the number of the signal lines needed.

In some embodiments, each of the switch transistors may be a P-type transistor. This is advantageous to reduce the process steps and thus lower the difficulty to manufacture. Of course, other embodiments are possible. For example, some or all of the switch transistors may be replaced by N-type transistors.

In an implementation, the capacitor module 200 may include a first capacitor. One terminal of the first capacitor is connected to the first node N1, and the other one to the third node N3.

In some embodiments, the pixel circuit may further include an auxiliary capacitor module 700. A first terminal of the auxiliary capacitor module 700 is connected to the third node N3, and a second terminal to the work voltage input terminal DD. In an implementation, the auxiliary capacitor module 700 may include a second capacitor. One terminal of the second capacitor is connected to the third node N3, and the other one to the work voltage input terminal DD. Since the voltage at the work voltage input terminal DD is generally constant, it may be ensured that the voltage at the third node N3 is kept constant, avoiding influencing the voltage at the first node N1 and thus the displayed luminance.

In an implementation, the electroluminescence module 400 may include an organic light-emitting diode (OLED).

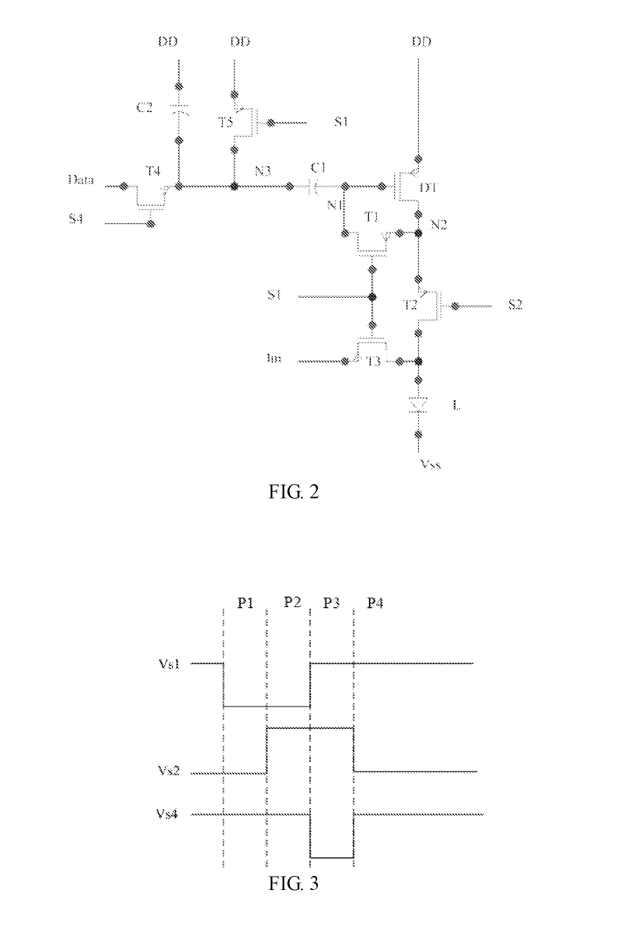

FIG. 2 is a schematic diagram of an exemplary circuit of the pixel circuit as described above. In this example, the control signal input terminal S1, the control signal input terminal S3 and the control signal input terminal S5 are one and the same input terminal (denoted as S1 hereinafter), and the reset voltage input terminal “Reset” and the work voltage input terminal DD are one and the same input terminal (denoted as DD hereinafter). Referring to FIG. 2, the pixel circuit may include a P-type driving transistor DT, P-type first to fifth switch transistors T1-T5, an electroluminescence element L, and capacitors C1 and C2. The pixel circuit further has a work voltage input terminal DD, an initialization voltage input terminal Ini, a low voltage input terminal Vss, a data voltage input terminal “Data”, and three control signal input terminal S1, S2 and S4. The source of the first switch transistor T1, the gate of the driving transistor DT, and the first terminal of the capacitor C1 are each connected to the first node N1. The drain of the first switch transistor T1, the source of the second switch transistor T2 and the drain of the driving transistor DT are each connected to the second node N2. The drain of the fourth switch transistor T4, the drain of the fifth switch transistor T5 and the second terminal of the capacitor C2 are connected to the third node N3. The gate of the first switch transistor T1, the gate of the third switch transistor T3 and the gate of the fifth switch transistor T5 are connected to the control signal input terminal S1. The gate of the second switch transistor T2 is connected to the control signal input terminal S2. The gate of the fourth switch transistor T4 is connected to the control signal input terminal S4. The drain of the second switch transistor T2 and the source of the third switch transistor T3 are connected to the anode of the electroluminescence element L. The source of the driving transistor DT, the source of the fifth switch transistor T5 and the first terminal of the second capacitor C2 are connected to the work voltage input terminal DD. The source of the fourth switch transistor T4 is connected to the data voltage input terminal “Data”. The cathode of the electroluminescence element L is connected to the low voltage input terminal Vss.

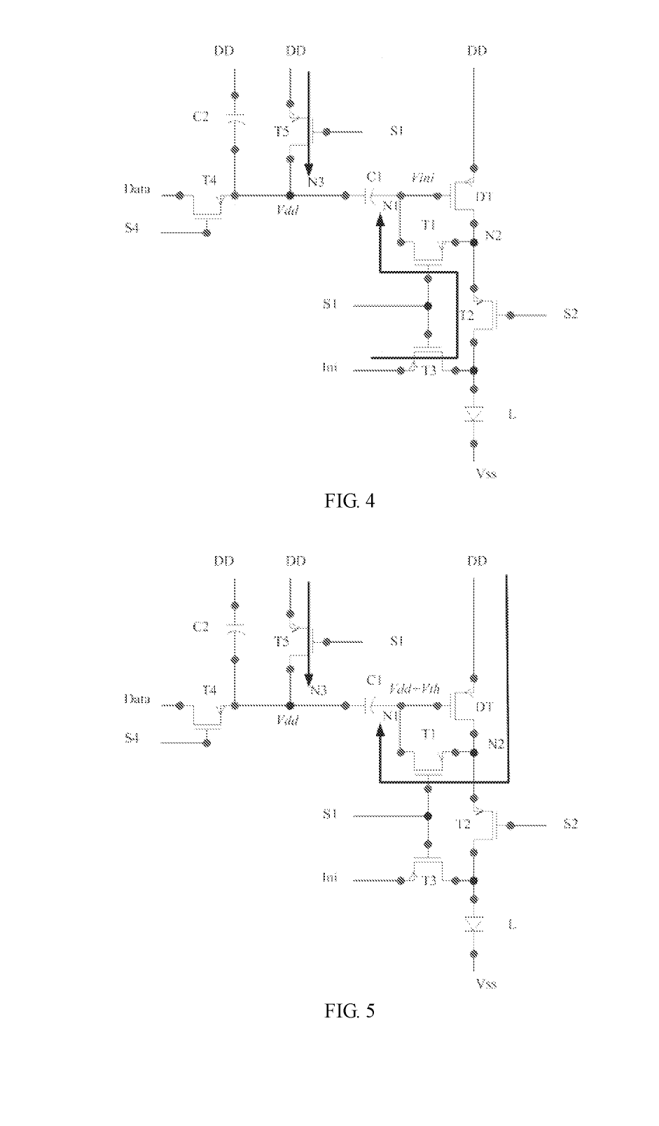

FIG. 3 is a timing diagram of example control signals for the pixel circuit as shown in FIG. 2. In this figure, Vs1 represents a signal applied to the control signal input terminal S1, Vs2 represents a signal applied to the control signal input terminal S2, and Vs4 represents a signal applied to the control signal input terminal S4.

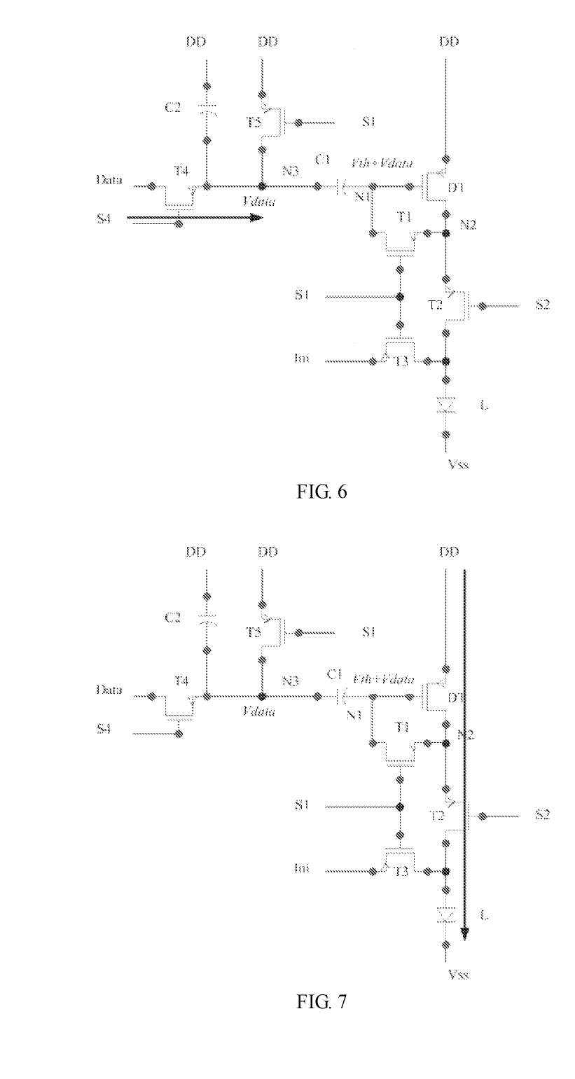

FIGS. 4-7 are schematic diagrams of operation states of the pixel circuit as shown in FIG. 2 in different phases.

At the initialization and reset phase P1, low levels are respectively applied to the control signal input terminals S1 and S2, and a high level is applied to the control signal input terminal S4. Referring to FIG. 4, the first switch transistor T1, the second switch transistor T2, the third switch transistor T3 and the fifth switch transistor T5 are in this case all turned on, and the fourth switch transistor T4 is turned off. The first node N1 is short-circuited to the initialization voltage input terminal Ini such that the voltage at the first node N1 is initialized to an initialization voltage Vini. The initialization of the first node N1 is completed. At the same time, the third node N3 is short-circuited to the work voltage input terminal DD, causing the voltage at the third node N3 to be reset as Vdd.

At the threshold voltage compensation phase P2, a low level is applied to the control signal input terminal S1, and high levels are respectively applied to the control signal input terminals S2 and S4. Referring to FIG. 5, the first switch transistor T1, the third switch transistor T3 and the fifth switch transistor T5 are in this case turned on, and the second switch transistor T2 and the fourth switch transistor T4 are turned off. The work voltage input terminal DD charges the first node N1 through the driving transistor DT and the first switch transistor T1 until the voltage at the first node N1 reaches Vdd+Vth (Vth is negative). At this time, the voltage at the third node N3 remains unchanged.

At the data voltage write phase P 3, high levels are respectively applied to the control signal input terminals S1 and S2, and a low level is applied to the control signal input terminal S4. Referring to FIG. 6, the first switch transistor T1, the second switch transistor T2, the third switch transistor T3 and the fifth switch transistor T5 are in this case all turned off, and the fourth switch transistor T4 is turned on. The data voltage input terminal “Data” charges the third node N3 through the fourth switch transistor T4 until the voltage at the first node N1 reaches the data voltage Vdata. Since the first node N1 is floated, the voltage at the first node N1 transitions, following the voltage at the third node N3. The voltage will be Vth+Vdata after the transition.

At the light emission phase P4, high levels are respectively applied to the control signal input terminals S1 and S4, and a low level is applied to the control signal input terminal S2. Referring to FIG. 7, the first switch transistor T1, the third switch transistor T3, the fourth switch transistor T4 and the fifth switch transistor T5 are in this case all turned off, and the second switch transistor T2 is turned on. The driving transistor DT generates a driving current that flows through the second switch transistor T2 and then is output to the electroluminescence element L.

From the saturation current formula, the current I_{L} flowing through the electroluminescence element L is:

$$\begin{matrix}{I}_{L} = {K ( {V}_{GS} - {V}_{th} )}^{2} \\ = {K ( Vth + Vdata - Vdd - Vth )}^{2} \\ = K \cdot {( Vdata - Vdd )}^{2}\end{matrix}$$

where K is a constant associated with the driving transistor DT. It can be seen from the above equation that the working current flowing through the electroluminescence element L is in theory not influenced by the threshold voltage Vth of the driving transistor, and is only relevant to the data voltage Vdata. This can avoid the influence on the current flowing through the electroluminescence element due to the drift of the threshold voltage Vth.

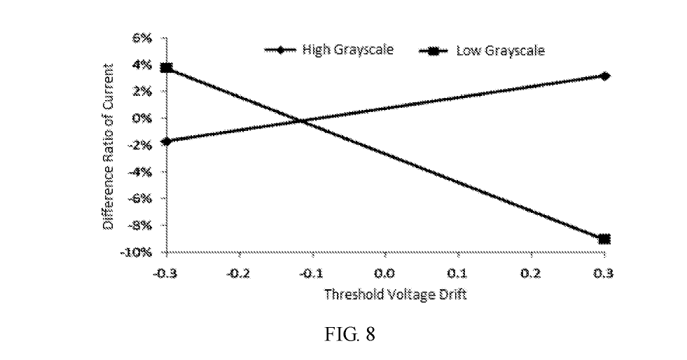

FIG. 8 is a graph showing a luminance variation versus a threshold voltage drift of the pixel circuit as shown in FIG. 2, wherein the luminance variation is represented by a current difference ratio. As can be seen from the figure, the variation ratio of the driving current over the threshold voltage is relatively small for both high grayscales and low grayscales. That is, the luminance is less influenced by the drift of the threshold voltage.

In the above embodiment, the threshold voltage compensation and light emission control module 300 is implemented by the first switch transistor T1, the second switch transistor T2 and the third switch transistor T3, the data voltage write module 500 is implemented by the fourth switch transistor T4, and the reset module 600 is implemented by the fifth switch transistor T5. In addition, the capacitor module 200 is implemented by the capacitor C1, and the auxiliary capacitor module 700 is implemented by the capacitor C2.

The pixel circuit as described above may be formed on a display substrate (not shown). The display substrate may be comprised in a display apparatus. The display apparatus here may be any product or component that has display functionality, such as electronic paper, a cell phone, a tablet, a television, a monitor, a laptop, a digital photo-frame, and a navigator.

It should be noted that the foregoing are merely specific embodiments of the present disclosure. Various improvements and modifications may be made by those skilled in the art without departing from the technical principle of the present disclosure. These improvements and modifications should be considered as falling within the scope of the present disclosure.

What is claimed is:

1. A pixel circuit comprising:
an electroluminescence module adapted to emit light in response to a driving current;
a driving module having a work voltage input terminal wherein the driving module is connected to a first node and a second node, wherein the driving module is adapted to generate and output to the second node the driving current based on a difference between a difference between a voltage at the first node and a work voltage input via the work voltage input terminal and a threshold voltage of the driving module;
a threshold voltage compensation and light emission control module having at least two control signal input terminals and an initialization voltage input terminal, wherein the threshold voltage compensation and light emission control module is connected to the first node, the second node and the electroluminescence module, wherein the threshold voltage compensation and light emission control module is adapted to compensate the voltage at the first node to a sum of the threshold voltage of the driving module and the work voltage in response to a combination of levels at the at least two control signal input terminals being a first level combination, wherein the threshold voltage compensation and light emission control module is adapted to initialize the first node by short-circuiting the first node to the initialization voltage input terminal in response to the combination of the levels at the at least two control signal input terminals being a second level combination, and wherein the threshold voltage compensation and light emission control module is adapted to direct the driving current output to the second node by the driving module to the electroluminescence module in response to the combination of the levels at the at least two control signal input terminals being a third level combination;
a data voltage write module having a data voltage input terminal and a control signal input terminal, wherein the data voltage write module is connected to a third node, wherein the data voltage write module is adapted to write a data voltage to the third node under control of a level at the control signal input terminal;
a reset module having a reset voltage input terminal and a control signal input terminal, wherein the reset module is connected to the third node, wherein the reset module is adapted to reset a voltage at the third node under control of a level at the control signal input terminal; and
a capacitor module having a first terminal connected to the first node and a second terminal connected to the third node.

2. The pixel circuit of claim 1, wherein the driving module comprises a P-type driving transistor having a gate connected to the first node, a drain connected to the second node, and a source connected to the work voltage input terminal.

3. The pixel circuit of claim 2, wherein the threshold voltage compensation and light emission control module comprises a first switch transistor, a second switch transistor and a third switch transistor, wherein the first switch transistor has a first source, a first drain, and a first gate connected to a first control signal input terminal, wherein one of either the first source or the first drain is connected to the first node and wherein the other one being is connected to the second node, wherein the second switch transistor has a second source, a second drain, and a second gate connected to a second control signal input terminal, wherein one of the second source or the second drain is connected to the second node and wherein the other one is connected to the electroluminescence module, and wherein the third switch transistor has a third source, a third drain, and a third gate connected to a third control signal input terminal, wherein one of the third source or the third drain is connected to the initialization voltage input terminal and wherein the other one is connected to the drain of the second switch transistor.

4. The pixel circuit of claim 3, wherein the third control signal input terminal and the first control signal input terminal are one and the same input terminal, and wherein the third switch transistor has the same threshold voltage as the first switch transistor.

5. The pixel circuit of claim 3, wherein the data voltage write module comprises a fourth switch transistor having a fourth source, a fourth drain, and a fourth gate connected to a fourth control signal input terminal, wherein one of the fourth source or the fourth drain is connected to the data voltage input terminal and wherein the other one being is connected to the third node.

6. The pixel circuit of claim 5, wherein the reset module comprises a fifth switch transistor having a fifth source, a fifth drain, and fifth gate connected to the first control signal input terminal or the third control signal input terminal, wherein one of the fifth source and or the fifth drain being is connected to the reset voltage input terminal and wherein the other one is connected to the third node.

7. The pixel circuit of claim 3, wherein each of the switch transistors is a P-type transistor.

8. The pixel circuit of claim 1, wherein the reset voltage input terminal and the work voltage input terminal are one and the same input terminal.

9. The pixel circuit of claim 1, further comprising an auxiliary capacitor module having a first terminal connected to the third node and a second terminal connected to the work voltage input terminal.

10. A method of driving a pixel circuit of,
wherein the pixel circuit comprises
an electroluminescence module adapted to emit light in response to a driving current;
a driving module having a work voltage input terminal wherein the driving module is connected to a first node and a second node, wherein the driving module is adapted to generate and output to the second node the driving current based on a difference between a voltage at the first node and a work voltage input via the work voltage input terminal and a threshold voltage of the driving module;
a threshold voltage compensation and light emission control module having at least two control signal input terminals and an initialization voltage input terminal, wherein the threshold voltage compensation and light emission control module is connected to the first node, the second node and the electroluminescence module, wherein the threshold voltage compensation and light emission control module is adapted to compensate the voltage at the first node to a sum of the threshold voltage of the driving module and the work voltage in response to a combination of levels at the at least two control signal input terminals being a first level combination, wherein the threshold voltage compensation and light emission control module is adapted to initialize the first node by short-circuiting the first node to the initialization voltage input terminal in response to the combination of the levels at the at least two control signal input terminals being a second level combination, and wherein the threshold voltage compensation and light emission control module is adapted to direct the driving current output to the second node by the driving module to the electroluminescence module in response to the combination of the levels at the at least two control signal input terminals being a third level combination;
a data voltage write module having a data voltage input terminal and a control signal input terminal, wherein the data voltage write module is connected to a third node, wherein the data voltage write module is adapted to write a data voltage to the third node under control of a level at the control signal input terminal;
a reset module having a reset voltage input terminal and a control signal input terminal, wherein the reset module is connected to the third node, wherein the reset module is adapted to reset a voltage at the third node under control of a level at the control signal input terminal; and
a capacitor module having a first terminal connected to the first node and a second terminal connected to the third node;
the method comprising:
initializing, at an initialization phase, the voltage at the first node by applying level signals of the second level combination to the control signal input terminals of the threshold voltage compensation and light emission control module;
resetting, at a reset phase, the voltage at the third node by applying a control signal to the control signal input terminal of the reset module;
compensating, at a threshold voltage compensation phase, the voltage at the first node to the sum of the threshold voltage of the driving module and the work voltage by applying level signals of the first level combination to the control signal input terminals of the threshold voltage compensation and light emission control module;
applying, at a data voltage write phase, a control signal to the control signal input terminal of the data voltage write module, and a data voltage to the data voltage input terminal; and
directing, at a light emission phase, the driving current output to the second node by the driving module to the electroluminescence module by applying level signals of the third level combination to the control signal input terminals of the threshold voltage compensation and light emission control module.

11. A display substrate comprising the pixel circuit of claim 1.

12. A display apparatus comprising the display substrate of claim 11.

13. The method of claim 10, wherein the driving module comprises a P-type driving transistor having a gate connected to the first node, a drain connected to the second node, and a source connected to the work voltage input terminal.

14. A method of claim 13, wherein the threshold voltage compensation and light emission control module comprises a first switch transistor, a second switch transistor and a third switch transistor, wherein the first switch transistor has a first source, a first drain, and a first gate connected to a first control signal input terminal, wherein one of either the first source or the first drain is connected to the first node and wherein the other one is connected to the second node, wherein the second switch transistor has a second source, a second drain, and a second gate connected to a second control signal input terminal, wherein one of the second source or the second drain is connected to the second node and wherein the other one is connected to the electroluminescence module, and wherein the third switch transistor has a third source, a third drain, and a third gate connected to a third control signal input terminal, wherein one of the third source or the third drain is connected to the initialization voltage input terminal and wherein the other one is connected to the drain of the second switch transistor.

15. A method of claim 14,
wherein the third control signal input terminal and the first control signal input terminal are one and the same input terminal, and wherein the third switch transistor has the same threshold voltage as the first switch transistor.

16. A method of driving of claim 14,
wherein the data voltage write module comprises a fourth switch transistor having a fourth source, a fourth drain, and a fourth gate connected to a fourth control signal input terminal, wherein one of the fourth source or the fourth drain is connected to the data voltage input terminal and wherein the other one is connected to the third node.

17. A method of claim 16, wherein the reset module comprises a fifth switch transistor having a fifth source, a fifth drain, and fifth gate connected to the first control signal input terminal or the third control signal input terminal, wherein one of the fifth source or the fifth drain is connected to the reset voltage input terminal and wherein the other one is connected to the third node.

18. A method of claim 14,
wherein each of the switch transistors is a P-type transistor.

19. A method of claim 10, wherein the reset voltage input terminal and the work voltage input terminal are one and the same input terminal.

20. A method of claim 10, wherein the pixel circuit further comprises an auxiliary capacitor module having a first terminal connected to the third node and a second terminal connected to the work voltage input terminal.
